(19) United States
(12) Patent Application Publication
(10) Pub. No.: US 2022/0351482 A1
(43) Pub. Date: Nov. 3, 2022

(54) TRAINING A SMART HOUSEHOLD APPLIANCE

(71) Applicant: BSH Hausgeraete GmbH, Muenchen (DE)

(72) Inventors: Clemens Hage, Muenchen (DE); Michal Nasternak, Warszawa (PL); Cristina Rico Garcia, Ottobrunn (DE)

(21) Appl. No.: 17/621,071

(22) PCT Filed: Jun. 18, 2020
(86) PCT No.: PCT/EP2020/066977

§ 371 Date: Dec. 20, 2021

(30) Foreign Application Priority Data
Jun. 24, 2019 (DE) 10 2019 209 062.1

(51) Int. Cl. G06V 10/24; G06T 7/55

(52) U.S. Cl. CPC G06V 10/245; G06T 7/55; G06T 2207/10028; G06T 2207/20081

(57) ABSTRACT

A method trains a recognition system for recognizing an object in an interior space of a household appliance. The method includes the steps of capturing images from a plurality of predetermined perspectives of the object placed on an alignment sheet; producing training data on the basis of the images; and training the adaptive recognition system using the training data.

The invention relates to a smart household appliance. In particular, the invention relates to a household appliance with a camera for identifying items in an interior space of the household appliance.

A smart refrigerator comprises a camera for recording an image of an interior space and a processing facility. The processing facility processes the image and is able to identify an object arranged in the interior space. For example, it is thus possible for different foods in the refrigerator to be recorded, which may be useful for creating a shopping list, for instance.

The identification preferably works by means of machine-implemented learning. The processing facility may already be trained to identify particular objects. To this end, the processing facility may, for example, implement an artificial neural network. Unknown objects cannot be identified, however, meaning that it is not possible to compile a complete inventory of the refrigerator.

WO2018212493A1 proposes a refrigerator with a camera attached on the inside and a display facility attached on the outside. A processing facility is able to identify an item in the refrigerator and display its name on the outside.

In order to train the processing facility to a new object, laboratory conditions should usually be established, in order to assign every known view to a precise perspective or distance from the camera in each case, for example. A user of the refrigerator usually lacks the necessary means for this, for example a controllable rotary disk, on which the object can be placed. Additionally, a manual provision of training data on the basis of scanning an object may be extremely time-consuming.

An object underlying the present invention consists in the specification of an improved technique for training an identification facility for identifying an object in an interior space of a household appliance to a new object. The invention achieves this object by means of the subject matter of the independent claims. Dependent claims represent preferred embodiments.

A method for training an identification facility for identifying an object in an interior space of a household appliance comprises steps of recording images of the object placed on an adjustment sheet from multiple (preferably predetermined) perspectives; generating training data on the basis of the images; and training the preferably adaptive identification facility using the training data.

In some embodiments, the adjustment sheet may be brought to predetermined positions with respect to a camera arranged in an immobile manner. In other embodiments, the camera itself is mobile and, for example, a user is able to record images of the object placed on the adjustment sheet from multiple perspectives, wherein a spatial allocation of the images in relation to one another is possible on the basis of the adjustment sheet to be identified in the images. A position of the object with respect to the adjustment sheet is preferably kept constant, in order to simplify the spatial allocation of the images in relation to one another. The adjustment sheet preferably comprises a thin, flat object, on which the object can be arranged. For example, the adjustment sheet may comprise a paper, a cardboard, a carton, a foil or a sheet. In this context, the adjustment sheet may carry a visual marking, so that its position on an image recorded by the camera can be determined. A position of the object can be easily determined on the basis of the determined position of the adjustment sheet. Thus, images of the objects from the predetermined perspectives can be produced in a simple manner. The images may be sufficient to train the identification facility.

A trained identification facility is able to identify the object, once it has been placed in the interior space of the household appliance, on an image which has been recorded by means of a camera directed into the interior space. In particular, the household appliance may comprise a refrigerator, a freezer, a climate-controlled cabinet or a cooking appliance such as a roaster, a steam cooker or an oven. Preferably, the household appliance is configured for storing the object. In another embodiment, however, the household appliance may also be configured for processing the object, wherein the object can be identified when a predetermined degree of processing has been reached. For example, the reaching of a predetermined degree of cooking of a dish accommodated in an oven can be determined on the basis of visual features.

In a preferred embodiment, a three-dimensional model of the object is created on the basis of the images, wherein the training data can be generated on the basis of the three-dimensional model. The three-dimensional model can be determined in a relatively simple manner on the basis of the images. The model can be post-processed, for example, in order to open or close a void that was not identified correctly on the basis of the images. Artifacts or gaps in the model can also be reduced or eliminated. These processing routines may take place manually or automatically. On the basis of the model, it is possible to create practically any given number of training data items that may be required in order to enable an identification of the object by the identification facility. If the identification facility works with an artificial neural network, then many thousands, many tens of thousands or many hundreds of thousands of training data items may be required for effective identification.

The adjustment sheet with the object can be moved to predetermined positions with respect to a camera for recording the images. To this end, an instruction to move the adjustment sheet with the object to a predetermined position with respect to the camera may be provided. The instruction may be output acoustically or visually, for example. The visual output may take place symbolically, textually or graphically.

It can be recorded that the adjustment sheet with the object is located at a predetermined position with respect to the camera. To this end, it is possible to record a confirmation of a person who is optionally positioning the adjustment sheet with the object. In another embodiment, the reaching of a predetermined position by the adjustment sheet can be determined on the basis of an image taken by the camera. In this case, it is possible to output a confirmation that the position has been reached. Usually, a predetermined number of positions is used, for example approx. 10-20.

According to a further aspect of the invention, a method for identifying an object in an interior space of a household appliance comprises steps of the method described herein of recording an image of the object in the interior space and identifying the object on the basis of the image. In other words, a method for identifying an object in the interior space of the household appliance may have been trained to the identification thereof in advance by means of a method described herein. The result of a first method described herein can be used by a second method for identifying the object.

According to yet another aspect of the present invention, a system comprises an adjustment sheet for placing an object on the adjustment sheet, a camera for recording images of the object placed on the adjustment sheet from multiple, preferably predetermined perspectives, and a processing facility. In this context, the processing facility is configured to generate training data on the basis of the images, and to train an adaptive identification facility using the training data.

The processing facility may be configured to fully or partially carry out a method described herein. To this end, the processing facility may comprise a programmable microcomputer or microcontroller and the method may be present in the form of a computer program product with program code means. The computer program product may in particular be present as an application (“app”) for a computer or a mobile device. The computer program product can also be saved on a computer-readable data carrier. Features or advantages of the method can be transferred to the apparatus, or vice versa.

The processing facility may be present locally in the region of the camera or the images recorded by means of the camera can be transmitted to a processing facility arranged at a remote location. In particular, the processing facility may be realized as a server or service, optionally in a cloud. The adjustment sheet may be provided as an electronic template, which can be printed out by a user. Different adjustment sheets may be provided for different objects, for example depending upon a size of the respective object.

The camera may comprise a depth camera. To this end, the camera is able to emit light according to the TOF (time of flight) principle and register light reflected at the object. A duration between the emitting and the registering of the light can be used to determine a distance from the object. In another embodiment, the camera may work according to the stereo principle. In this context, multiple images from slightly different perspectives can be produced simultaneously and depth information can be determined on the basis of deviations between the images.

On the basis of images with depth information, it is possible for training data or a three-dimensional model for providing training data to be generated in a simpler or more precise manner.

Moreover, the system may comprise a projection facility for projecting a positioning mark onto a surface, on which the adjustment sheet with the object is to be placed. By means of the projection facility, an indication for the positioning of the adjustment sheet can be output. For example, the projection may comprise outlines of the correctly placed adjustment sheet, so that an operator is easily able to reposition the adjustment sheet on the projection. The camera and the projection facility may be consolidated into a projection and interaction facility (PAI). In this context, the PAI may be configured for attachment above a countertop. The adjustment sheet may be placed or positioned on the countertop.

In another embodiment, the camera is part of a smartphone. The smartphone can be positioned in a fixed manner by means of a stand, for example. Subsequently, only the position of the adjustment sheet with the object can be changed with respect to the smartphone. The smartphone may already contain necessary facilities for controlling the camera and for processing or for transmitting data to a remote location. A user can use an available smartphone to implement the present invention. Investment costs for implementing the technique proposed herein can be reduced. An application necessary for the technique can easily be installed on the smartphone.

The invention will now be described in more detail with reference to the accompanying figures, in which

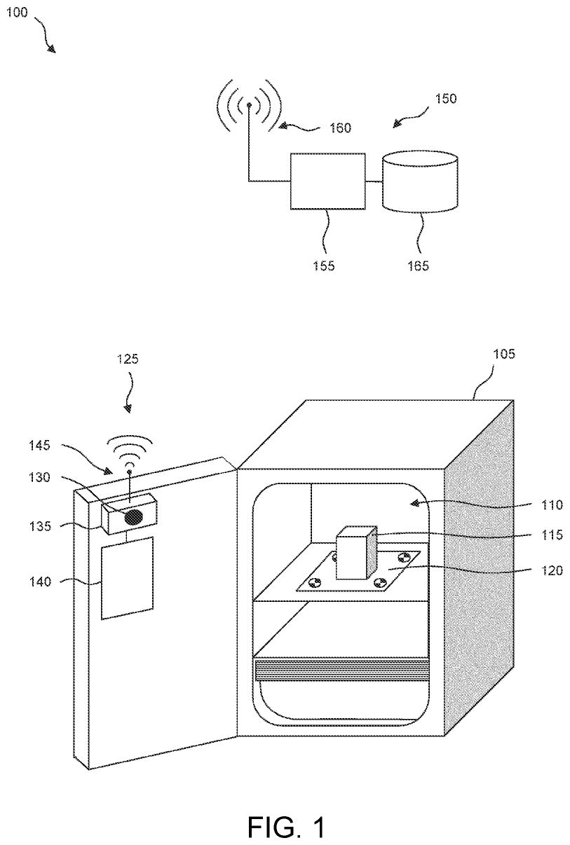

FIG. 1 shows an exemplary system with a household appliance;

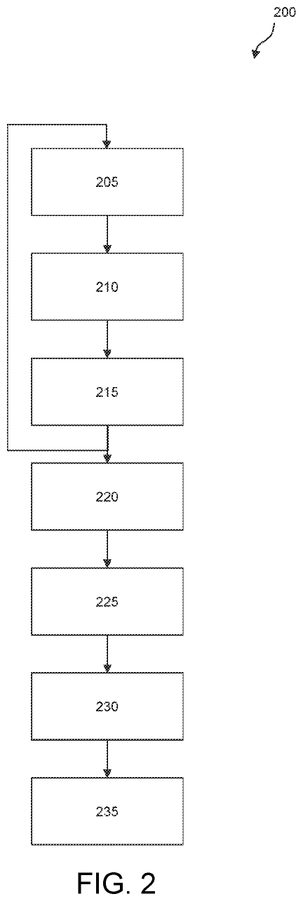

FIG. 2 shows an exemplary method for training a household appliance;

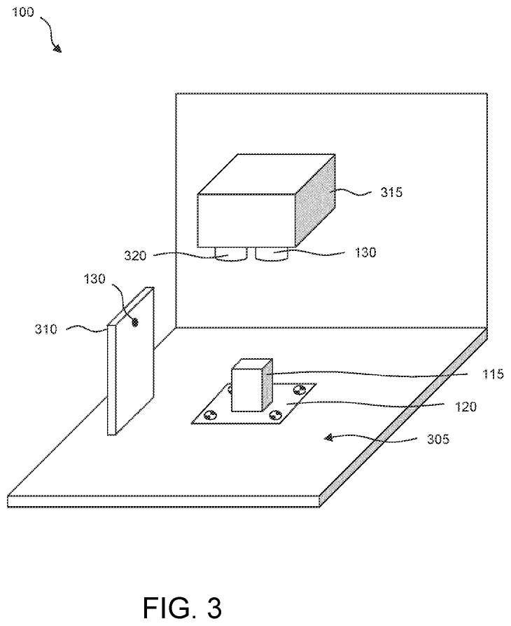

FIG. 3 shows exemplary variants of apparatuses for recording images of an object; and

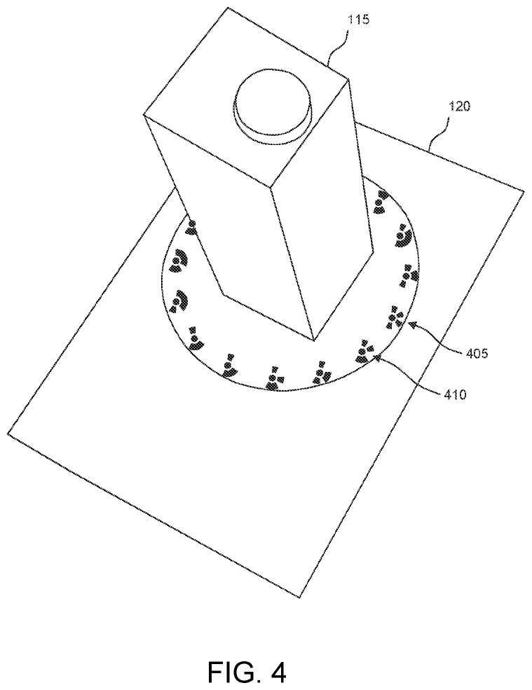

FIG. 4 shows an exemplary adjustment sheet with an object.

FIG. 1 shows an exemplary system 100 with a household appliance 105, which here is designed as a refrigerator by way of example. The household appliance 105 comprises an interior space 110, in which an object 115 can be arranged. The object 115 usually comprises a foodstuff, for example a food, a dish or an ingredient. In this context, a container of the object 115 may vary; for example, the same foodstuff may be present in different packaging or sizes. In the present case, the object 115 is placed on an adjustment sheet 120, which is positioned in the interior space 110.

An identification facility 125 comprises a camera 130 that can be directed into the interior space 110, a processing facility 135, as well as optionally an output apparatus 140, here in the form of a graphical output apparatus 140, or a communication apparatus 145. The processing facility 135 preferably comprises a microcomputer. The output apparatus 140 may provide textual or graphical outputs, for example. In this context, the output may be provided on the inside and/or the outside of the household appliance 105. Optionally, an acoustic output apparatus 140 is provided.

The communication facility 145 is configured for communication with an external facility 150. In a usual operation of the household appliance 105, a content of the household appliance 105 can be identified and processed and the processed information can be transmitted to the external facility 150, for example in text form. The external facility 150 can forward the information, for example to a fixed or mobile device of a user of the household appliance 105. The information can also be routed directly to the device of the user by means of the communication facility 145.

For a technique described herein, the external facility 150 can be configured for the training of the identification facility 125. To this end, a dedicated facility 150 may be provided, which differs from the facility 150 for the processing or transmitting of information regarding identified objects 115. The tasks of the external facility 150 can also be performed locally by the processing facility 135 of the identification facility 125 or another local processing facility. The external facility 150 preferably comprises a processing facility 155, a communication facility 160 and an optional storage apparatus 165.

It is proposed to record, by means of the camera 130, a number of images of the object 115 placed on the adjustment sheet 120, and on the basis of the images to train the processing facility 135 in order to identify the object 115. To this end, the images are preferably transmitted to the external facility 150, where a three-dimensional model of the object 115 is determined therefrom. On the basis of the model, it is possible to generate training data, which in particular may comprise views of the object 115 from various perspectives or with various coverage by other items. The training data may be used to train a computer-implemented system that is capable of learning. The system, or a characteristic part thereof, may be transmitted back to the identification facility 125, in order to identify the object 115 in the interior space 110 of the household appliance 105 on an image recorded by means of the camera 130. In particular, the trained system may comprise an artificial neural network, and characteristic parameters, in particular regarding an arrangement and/or interconnection of artificial neurons, can be transmitted.

FIG. 2 shows a flow diagram of a method 200 for training an identification facility 120. In particular, the method may be carried out by means of a system 100. It should be noted that the elements shown in FIG. 1 preferably are primarily used to identify the object 115 if the identification facility 125 has already been trained accordingly. Training described in the following can be carried out with such elements. Preferably, however, other facilities are used, which are explained in more detail further below.

In a step 205, the object 115 is placed on the adjustment sheet 120, wherein the adjustment sheet 120 is brought to a predetermined position, from which the camera 130 has a predetermined perspective of the object 115. The position can be determined in a dynamic manner, for example on the basis of a size of the object 115. An indication of the predetermined position may be output by means of the output facility 140. If the adjustment sheet 120 has assumed the position, this can be identified on the basis of an image taken by the camera 130, or an actuation of an input apparatus can be recorded.

In a step 210, an image of the object 115 on the adjustment sheet 120 can be recorded. In this context, the entire object 115 and at least a predetermined section of the adjustment sheet 120 are depicted, wherein the section may show a visual marking that can be used to determine a position and/or orientation of the adjustment sheet 120.

In a step 215, it can be determined whether there are already sufficient images of the object 115 on the adjustment sheet 120 from different, predetermined positions with respect to the camera 130. If this is not the case, the steps 205 and 210 may be run through once again. It should be noted in step 205 that, although the adjustment sheet 120 can be moved with respect to the camera 130, an orientation and position of the object 115 with respect to the adjustment sheet 120 preferably remains unchanged.

In a step 220, a three-dimensional model of the object 115 can be determined. This step is preferably performed on the part of the external facility 150. The three-dimensional model is configured to show the object 115 to the greatest possible extent from all views that the object 115 is able to assume with respect to the camera 130. To this end, information of the images can accordingly be combined and aligned with one another. The model preferably only reflects visual features of the object 115.

In a step 225, training data can be generated on the basis of the model. In each case, the training data may comprise a view of the object 115 from a predetermined perspective. Optionally, the view is subjected to a predetermined impairment, for example being partially obscured by another object.

In a step 230, the identification facility 125 can be trained on the basis of the training data. In practice, it is not the identification facility 125 of the household appliance 105 that is trained, but rather a copy or a derivative of characteristic parts of the identification system 125, in particular in the form of an artificial neural network.

In a step 235, the identification facility 235 can be used to produce an image of the object 115 in the interior space 110 by means of the camera 130 and to identify the object 115 or to segment the image in order to isolate, identify or single out the object 115.

The use of the household appliance 105 to produce images, which ultimately can be used by the method 200 to train the identification facility 125, may be time-consuming, as for the correct arrangement of the object 115 on the adjustment sheet 120 in each case a door of the household appliance has to be opened and closed again in order to record an image. In addition, a quality of the camera 130 may be limited. A perspective of the camera 130 may be suboptimal for the present purpose. Lighting in the household appliance 105 furthermore may be relatively weak, meaning that the images are unable to achieve a high quality.

FIG. 3 shows exemplary variants of apparatuses that may be better suited to recording images of an object 115 for the generation of training data. Without restricting the generality, it is assumed that the object 115 placed on the adjustment sheet 120 is located on a surface 305 that in particular is able to run horizontally and may form the top side of a countertop.

A first apparatus 310 comprises a mobile device, for example a laptop computer, a tablet computer or a smartphone. Usually, the device comprises a camera 130 as well as a processing facility 135 and a communication facility 145. In order to perform the method 200, in particular the steps 205-215, the device can be brought into a constant position with respect to the surface 305 by means of a stand.

A second apparatus 315 comprises a PAI, which usually may be attached above the surface 305, for example on the bottom side of a wall cupboard or shelf, or on a vertical wall. In a further embodiment, the apparatus 315 may also be held above the surface 305 by means of a mast.

Usually, the PAI comprises a camera 130, a processing facility 135 and a communication facility 145. Additionally provided as an output apparatus 140 is a projector 320, which may be attached with a slight lateral offset from the camera 130. The projector 320 is preferably configured to project a representation on the surface 305 and the camera 130 may be configured to determine a position of an object, in particular a hand of a user, with respect to the representation. The PAI may be advantageously used in a particular manner to project a desired position for the adjustment sheet 120 onto the surface 305. If the adjustment sheet 120 assumes the projected position, then this can be determined by means of the camera 130. Alternatively, an input of a user can be recorded. The input may take place in relation to a button projected onto the surface 305.

Both apparatuses 310, 315 can be easily used by a user of the household appliance 105. Other embodiments of apparatuses 310, 315 are likewise possible.

FIG. 4 shows an exemplary adjustment sheet 120, on which an object 115 is placed. The representation is produced from an elevated position and with optics of the camera 130 at a short focal distance, meaning that noticeable perspective distortions are produced. By way of example, the object 115 is substantially cuboid in shape and may, for example, comprise a carton of milk. Print on the packaging is not shown.

The adjustment sheet 120 preferably carries an arrangement 405 with at least one visual marking 410. The markings 410 shown are arranged at even relative distances on a circular line, in the region of which the object 115 is placed. Due to the size of the object 115, it is not possible for all markings 410 to be seen by the camera 130 at the same time. By way of example, the markings 410 each comprise a centering point, about which one or more circular arcs are shown.

### REFERENCE CHARACTERS

100 System

105 Household appliance

110 Interior space

115 Object

120 Adjustment sheet

125 Identification facility

130 Camera

135 Processing facility

140 Output apparatus

145 Communication facility

150 External device

155 Processing facility

160 Communication facility

165 Storage apparatus

200 Method

205 Placed object on adjustment sheet

210 Recorded image of the object

215 Are there sufficient images?

220 Create 3D model of the object

225 Generate training data

230 Train identification unit

235 Use identification unit

305 Surface

310 First apparatus

315 Second apparatus

320 Projector

405 Arrangement

410 Marking

1-10. (canceled)

11. A method for training an adaptive identification facility for identifying an object in an interior space of a household appliance, which comprises the following steps of:
recording images of the object placed on an adjustment sheet from multiple perspectives;
generating training data on a basis of the images; and
training the adaptive identification facility using the training data.

12. The method according to claim 11, which further comprises creating a three-dimensional model of the object on a basis of the images and the training data is generated on a basis of the three-dimensional model.

13. The method according to claim 11, which further comprises moving the adjustment sheet with the object to predetermined positions with respect to a camera for recording the images.

14. The method according to claim 13, which further comprises providing instructions to move the adjustment sheet with the object to a predetermined position with respect to the camera.

15. The method according to claim 14, which further comprises recording the adjustment sheet with the object being located at the predetermined position with respect to the camera.

16. The method according to claim 11, which further comprises recording the images of the object placed on the adjustment sheet from multiple, predetermined perspectives.

17. A method for identifying an object in an interior space of a household appliance, which comprising the steps of:
recording images of the object placed on an adjustment sheet from multiple perspectives;
generating training data on a basis of the images;
training an adaptive identification facility using the training data; and
recording an image of the object in the interior space and an identifying of the object on a basis of the image.

18. A system, comprising:
an adjustment sheet for placing an object on said adjustment sheet;
a camera for recording images of the object placed on said adjustment sheet from multiple perspectives; and
a processor configured to generate training data on a basis of the images and to train an adaptive identification facility using the training data.

19. The system according to claim 18, wherein said camera includes a depth-sensing camera.

20. The system according to 18, further comprising a projection facility for projecting a position mark on a surface, on which said adjustment sheet with the object is to be placed.

21. The system according to claim 18, wherein said camera is part of a smartphone.
